(19) United States
(12) Patent Application Publication
(10) Pub. No.: US 2015/0281417 A1
(43) Pub. Date: Oct. 1, 2015

(54) Auxiliary Device for Mobile Terminal and Mobile Terminal Product

(71) Applicants: BOE TECHNOLOGY GROUP CO., LTD., Beijing (CN); BOE (HEBEI) MOBILE DISPLAY TECHNOLOGY CO., LTD., Hebei (CN)

(72) Inventors: Junjie MIAO, Beijing (CN); Guangquan WANG, Beijing (CN); Moyu ZHU, Beijing (CN)

(21) Appl. No.: 14/445,620

(22) Filed: Jul. 29, 2014

(30) Foreign Application Priority Data
Mar. 25, 2014 (CN) 201410114164.7

(51) Int. Cl. H04M 1/02; A45F 5/00

(52) U.S. Cl. CPC H04M 1/0279; A45F 5/00; A45F 2005/008

(57) ABSTRACT

The present invention relates to the field of telecommunication technology, in particular to an auxiliary device for a mobile terminal and a mobile terminal product. The auxiliary device includes a housing for receiving and securing the mobile terminal, and a peripheral controlling member for controlling the mobile terminal. The peripheral controlling member makes identification and exchanges information with the mobile terminal, and the peripheral controlling member is mounted on the housing. According to the present invention, the auxiliary device for a mobile terminal is able to connect the peripheral controlling member to the mobile terminal conveniently, and to solve the problem that the mobile terminal cannot be operated conveniently.

### CROSS-REFERENCE TO RELATED APPLICATION

The present application claims and enjoys a priority of the Chinese patent application No. 201410114164.7, filed on Mar. 25, 2014 and entitled “auxiliary device for mobile terminal and mobile terminal product”, which is incorporated herein by reference in its entirety.

### TECHNICAL FIELD

The present invention relates to the field of telecommunication technology, in particular to an auxiliary device for a mobile terminal, and a mobile terminal product.

### BACKGROUND

Along with the rapid development of IC technologies, the mobile communication industry is going to a real mobile information age. A mobile terminal, with strong processing capacity, is now changing from a simple communication tool to a comprehensive information processing platform, which results in a board space for the development of the mobile terminal. In order to view information on the mobile terminal in a clearer manner, the mobile terminal, such as a mobile phone, is required to have a larger volume and thereby a larger screen. As a result, it is harder to operate the mobile terminal to some extent.

In the prior art, a Chinese patent application (CN01258909.8), entitled “additional rocker for mobile phone”, discloses a method for controlling keys via a rocker, in which the keyboard is sheathed with the rocker and controlled via the rocker in a mechanical transmission manner.

This method is merely used to change “control by keyboard” into “control by rocker” through the mechanical transmission. However, it is hard to implement this method and operate the mobile phone, because a thickness of the mobile phone will increase due to the addition of the rocker. Moreover, a development trend of the current mobile phone is to gradually omit the keys, so it is impossible for the method using the rocker to effectively operate the mobile terminal without any keys.

Hence, there is a need to provide an auxiliary device for the mobile terminal so as to overcome the above-mentioned drawbacks.

### SUMMARY

An object of the present invention is to solve the problem that an existing mobile terminal, especially the mobile terminal without any keys cannot be operated conveniently.

In one aspect, the present invention provides an auxiliary device for a mobile terminal, includes a housing for receiving and securing the mobile terminal, and a peripheral controlling member for controlling the mobile terminal. The peripheral controlling member makes identification and exchanges information with the mobile terminal, and the peripheral controlling is mounted on the housing.

The auxiliary device of the above embodiment of the present invention is able to connect the peripheral controlling member to the mobile terminal conveniently, and to solve the problem that the mobile terminal cannot be operated conveniently.

According to the auxiliary device of the above embodiments of the present invention, at least one fingerstall is secured to or detachably mounted on a back of the housing, and a wristlet is secured or detachably connected to the housing. In addition, the peripheral controlling member is secured to, or rotatably mounted on, or detachably mounted on the housing.

Through the fingerstall and the wristlet, it is able to comfortably and safely secure the mobile terminal to a hand, so that the mobile terminal, when used, can be held in one hand. In addition, a first finger, a middle finger and a third finger may be secured in the fingerstalls, so they may not occupy a position of a palm.

According to the auxiliary device of the above embodiments of the present invention, the wristlet is a flexible member with a T shape, and includes a vertical member and a transverse member arranged at one end of the vertical member. Another end of the vertical member is secured or detachably connected to the housing, and the transverse member is configured to be detachably sheathed onto a wrist of a user.

According to the auxiliary device of the above embodiments of the present invention, the transverse member of the wristlet is spaced from the fingerstall at a distance of about half a length of the palm.

The auxiliary device of the above embodiments of the present invention is able to conveniently secure the auxiliary device for the mobile terminal at an appropriate position of the hand.

According to the auxiliary device of the above embodiments of the present invention, the housing includes an inner shell and a soft shell arranged at a part of, or the whole of, an outer surface of the inner shell. The peripheral controlling member is secured to or rotatably mounted on the inner shell, and one end of the wristlet is connected to the soft shell, and the fingerstall is mounted on a back of the soft shell.

According to the auxiliary device of the above embodiments of the present invention, the auxiliary device for the mobile terminal will feel comfortable, have a beautiful appearance and can be processed easily.

According to the auxiliary device of the above embodiments of the present invention, the housing has a shape at its inner side that matches a shape of a case of the mobile terminal, and the mobile terminal can be embedded or slidably inserted into the housing.

According to the auxiliary device of the above embodiments of the present invention, the housing is used as a part of the case of the mobile terminal.

The auxiliary device of the above embodiments of the present invention is able to assemble the auxiliary device for the mobile terminal with the mobile terminal easily.

According to the auxiliary device of the above embodiments of the present invention, the transverse member of the wristlet is provided at both ends with a perforated belt and a buckle, or a pair of hook and loop fasteners, or a pair of magnetic buckles, or a pair of snaps, and the transverse member of the wristlet is detachably sheathed onto the wrist.

According to the auxiliary device of the above embodiments of the present invention, there are two or three fingerstalls, and each fingerstall is of a ring shape with an adjustable diameter.

According to the auxiliary device of the above embodiments of the present invention, the peripheral controlling member includes an input member, a driving module and a signal connection member for making identification and exchanging information with the mobile terminal.

According to the auxiliary device of the above embodiments of the present invention, the input member is a rocker, a keyboard and/or a touch panel.

According to the auxiliary device of the above embodiments of the present invention, the signal connection member is a wired or wireless signal connection member, and an interface of the driving module is arranged in correspondence to a controlling module of a keyboard or a touch screen of the mobile terminal.

According to the auxiliary device of the above embodiments of the present invention, the peripheral controlling member is arranged at one side of the housing, and the wristlet is also connected to said one side of the housing, and the wristlet is connected at a position where the peripheral controlling member can be operated by a thumb in use.

In another aspect, the present invention provides a mobile terminal product comprising a mobile terminal and an auxiliary device arranged on the mobile terminal. The auxiliary device comprising a housing for receiving and securing the mobile terminal, and a peripheral controlling member for controlling the mobile terminal. The peripheral controlling member makes identification and exchanges information with the mobile terminal, and the peripheral controlling member is mounted on the housing.

According to the mobile terminal product of the above embodiment of the present invention, at least one fingerstall is secured to or detachably mounted on a back of the housing, and a wristlet is secured or detachably connected onto the housing, and the peripheral controlling member is secured to, or rotatably mounted on, or detachably mounted on, the housing.

According to the mobile terminal product of the above embodiment of the present invention, the housing has a shape at its inner side that matches a shape of a case of the mobile terminal, and the mobile terminal can be embedded or slidably inserted into the housing, or the housing is used as a part of the case of the mobile terminal.

According to the mobile terminal product of the above embodiment of the present invention, the peripheral controlling member includes an input member, a driving module and a signal connection member for making identification and exchanging information with the mobile terminal.

According to the mobile terminal product of the above embodiment of the present invention, the input member is a rocker, a keyboard or a touch panel.

According to the mobile terminal product of the above embodiment of the present invention, the signal connection member is a wired or wireless signal connection member, and an interface of the driving module is arranged in correspondence to a controlling module of a keyboard or a touch screen of the mobile terminal.

According to the mobile terminal product of the above embodiment of the present invention, the peripheral controlling member is arranged at one side of the housing, and the wristlet is also connected to said one side of the housing. And the wristlet is connected at a position where the peripheral controlling member can be operated by a thumb in use.

According to the auxiliary device for the mobile terminal of the above embodiments of the present invention, the mobile terminal, especially the mobile terminal without any keys, can be conveniently operated by the peripheral controlling member of the auxiliary device.

According to the auxiliary device for the mobile terminal of the further embodiments of the present invention, the mobile terminal, when used, can be held in one hand by means of the auxiliary device. The first finger, the middle finger and/or the third finger are secured in the fingerstalls, and will not occupy the position of the palm. The peripheral controlling member in the form of a rocker, a keyboard or a touch panel in communication with the mobile terminal, is able to be operated and controlled by the thumb. As a result, a large-screen mobile terminal is able to be conveniently hold, carried and operated by one hand, thereby to solve the problem that the large-screen mobile terminal cannot be carried conveniently and must be operated by two hands. In addition, the control of the auxiliary device over the mobile terminal is not limited by its original controlling units, and the carrying and operation of the large-size mobile terminal, such as a mainstream large-screen mobile terminal, will be improved obviously.

### BRIEF DESCRIPTION OF THE DRAWINGS

FIG. 1 is a perspective schematic view showing an auxiliary device for a mobile terminal according to the first embodiment of the present invention;

FIG. 2 is a perspective schematic view showing the auxiliary device for the mobile terminal according to the second embodiment of the present invention;

FIG. 3 is a perspective schematic view showing the auxiliary device for the mobile terminal according to the third embodiment of the present invention; and

FIG. 4 is a logical schematic diagram showing how the auxiliary device for the mobile terminal works.

### DETAILED DESCRIPTION

In order to make the objects, the technical solutions and the advantages of the present invention more apparent, the present invention will be described hereinafter in a clear and complete manner in conjunction with the drawings. Obviously, the followings are merely a part of, rather than all of, the embodiments, and the other embodiments obtained by a person skilled in the art based on these embodiments, without any creative effort, shall also fall within the scope of the present invention.

### First Embodiment

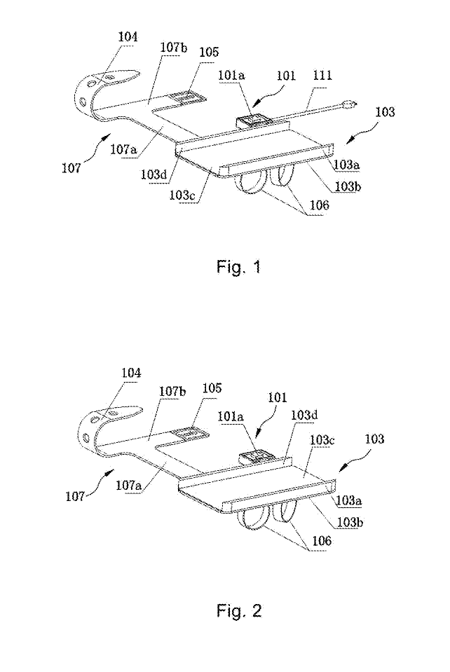

As shown in FIG. 1, an auxiliary device for a mobile terminal according to the first embodiment of the present invention includes fingerstalls 106, a wristlet 107, a housing 103 and a peripheral controlling member 101 for controlling a mobile terminal. The peripheral controlling member 101, which makes identification with the mobile terminal and exchanges information therewith, is mounted on the housing 103, the wristlet 107 is connected to the housing 103, and the fingerstall 106 is mounted on a back of the housing 103. The peripheral controlling member 101 adopts rocker, keyboard or touch panel technique, and has such functions as stepping, selecting and determining, and so on. The peripheral controlling member 101 adopting the rocker, keyboard or touch panel technique corresponds to a keyboard function or touch screen of the mobile terminal, while that adopting technique corresponds to a touch function of the mobile terminal. The peripheral controlling member is operated by fingers so as to control the mobile terminal.

The housing 103 may be made of any materials and have any structures, which are not particularly defined herein, as long as it can partially or completely receive and secure the mobile terminal. For example, it may be made of a hard material, such as a thermoplastic resin, a metal or an alloy, and so on, or a flexible material, such as rubber, artificial leather or skin, or fabric, and so on. The structure and size of the housing 103 may be designed in accordance with shapes and sizes of different mobile terminals, so that the housing has a shape matching the shape of a case of the mobile terminal. As an example, shown in FIGS. 1-3, the housing 103 has a bottom plate 103c and two side walls 103d extending upward along two sides of the bottom plate. The mobile terminal may be embedded into a space surrounded by the bottom plate 103c and the side walls 103d. Alternatively, four side walls may also be formed.

Alternatively, in order to facilitate the mounting of the mobile terminal, the housing 103 may be made of a moldable and elastic material, e.g., a thermoplastic resin, a metal or an alloy, and so on, so as to provide high toughness and strength. In use, the housing 103 receives the mobile terminal, and it is tightly attached to the case thereof. As a result, the auxiliary device may be assembled conveniently, feel comfortable, and have a light weight.

Alternatively, the housing 103 includes an inner shell 103a made of the above-mentioned moldable and elastic material and a soft shell 103b. The inner shell 103a is used to receive and secure the mobile terminal therein. Alternatively, the soft shell 103b may be provided at a part of, or the whole of, an outer surface of the inner shell 103a, so as to improve the comfort level and appearance. It is to be noted that, the soft shell 103b is not necessary.

Alternatively, the peripheral controlling member 101 may be mounted on the inner shell 103a via a rotary shaft. In use, a relative position between the peripheral controlling member 101 and the inner shell 103a is adjusted through the rotary shaft. Optionally, the peripheral controlling member 101 may be coupled to the inner shell 103a in other ways, or to the soft shell 103a, as long as the peripheral controlling member 101 is mechanically coupled to the housing 103 without affecting the arrangement of the mobile terminal within the housing 103.

The peripheral controlling member 101 may be a peripheral input element, e.g., that including an input member 101a, a driving module and a signal connection member, and so on. Alternatively, the input member 101a may be a rocker, a keyboard or a touch panel. As shown in FIG. 1, the signal connecting member may be a USB data line 111. The driving module is connected to the mobile terminal via the USB data line 111, so as to control the mobile terminal by means of the peripheral controlling member in the form of a rocker, keyboard or touch panel. Alternatively, an interface of the driving module is arranged in correspondence to a controlling module of the keyboard or touch screen of the mobile terminal.

Alternatively, as shown in FIG. 1, the peripheral controlling member 101 is arranged at one side of the housing 103 to which the wristlet is connected, so as to operate the input member 101a of the peripheral controlling member 101 by a thumb.

Alternatively, the wristlet 107 is a member capable of coupling the housing 103 and the mobile terminal within the housing 103 to a wrist of a user. The wristlet 107 may be a flexible one, and have a T-shaped structure as shown in FIG. 1. It includes a vertical member 107a and a transverse member 107b connected to one end of the vertical member 107a. Another end of the vertical member 107a is secured or detachably connected to the housing 103, and the transverse member 107b is detachably sheathed onto the wrist. In FIG. 1, the transverse member 107b is provided at both ends with a perforated belt 104 and a buckle 105, which cooperate with each other so as to be fit to different size wrists. Such a structure is simple and practicable.

FIGS. 1-3 are merely used to show the structures of the transverse member 107b in a better manner. In fact, in use, the transverse member 107b should be bent downward, so as to form a ring-shaped member about the wrist.

The wristlet 107 may be made of a flexible material such as plastics, rubber or fabrics. The connection type between the wristlet 107 and the housing 103 may be selected in accordance with the materials of the housing 103 and the wristlet 107, and whether or not the wristlet 107 is to be detached from the housing 103. For example, the wristlet 107 may be connected to the housing 103 by hot fusing, adhering, snap fitting, hook and loop fastener or clamping, and so on. The wristlet 107 may be provided at any position according to the practical need, as long as the transverse member can surround the wrist when the user faces the mobile terminal and the fingers are inserted into the fingerstalls. Because the wristlet 107 is made of the flexible material, it is able to flex the wrist freely in use.

Alternatively, the fingerstall 106 is provided on a back of the soft shell 103b or the housing 103. Preferably, there are two or three ring-shaped fingerstalls 106. In order to adjust the diameter of the fingerstall 106 in accordance with a size of the finger, it may be formed as an overall ring-shaped member made of an elastic material, or formed with two sections that can be detachably connected to each other. These two sections may be snap-fitted or clamped together, or connected together by hook and loop fastener, and so on, so as to form the ring-shaped fingerstall. The fingerstall 106 may be used to ensure that the mobile terminal is held in one hand when used. The first, middle and/or third fingers may be secured in the fingerstalls, and will not occupy a position of a palm. The fingerstalls may be secured onto, or formed integrally with, the soft shell 103b or the housing 103, or detachably provided on the soft shell 103b or the housing 103 by hot fusing, adhering, snap fitting, hook and loop fastener or embedding.

Alternatively, the housing 103, the wristlet 107 and the fingerstall 106 may be formed separately and then coupled together, or formed integrally.

The wristlet 107 and the fingerstall 106 may be detachably provided on the housing 103, so that they can be removed when they are not needed. As a result, it is able to carry and store the auxiliary device for the mobile terminal more conveniently.

According to the auxiliary device for the mobile terminal of the first embodiment, it is able to hold and carry the mobile terminal in one hand, e.g., a large-screen mobile terminal such as a mobile phone and a tablet PC, and to operate the mobile terminal by one hand.

### Second Embodiment

As shown in FIG. 2, the auxiliary device is designed in such a manner so as to prevent the operation of the mobile terminal from being limited by its original control units, and to improve the carrying and operation of a large-size mobile terminal such as a mainstream large-screen one.

The same technical contents in the first embodiment and the second embodiment are not described again here. This embodiment differs from the first embodiment in that a Bluetooth controlling module is added in the driving module of the peripheral controlling member 101, so that the driving module is in communication with the mobile terminal through the Bluetooth. Through such a connection mode via a wireless signal, it is able to overcome the situation where a bad connection is established via the USB data line 111.

Meanwhile, the inner shell 103a may be used as the case of the mobile terminal, so as to save the materials and reduce the overall weight of the mobile terminal, thereby to make it portable. For example, when the mobile terminal is a mobile phone, the housing 103 may be a rear housing of the mobile phone, and the auxiliary device serving as the rear housing may be assembled with a body of the mobile phone.

### Third Embodiment

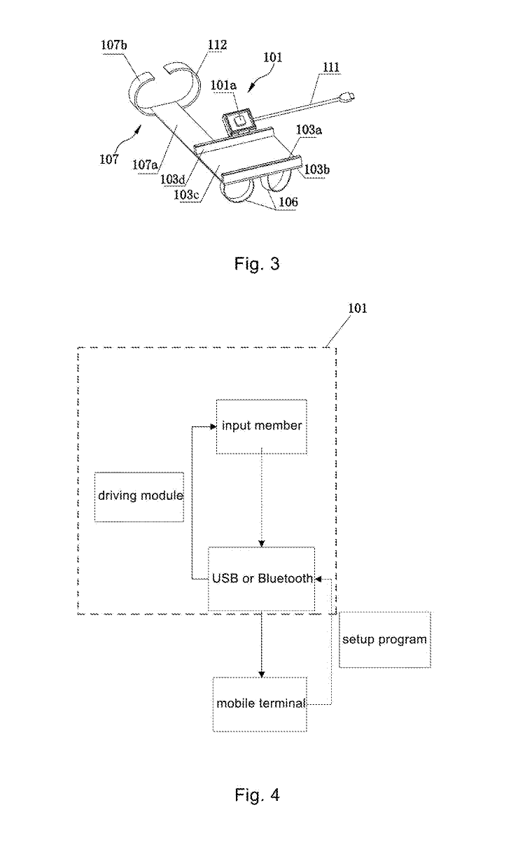

The same technical contents in the first embodiment and the third embodiment are not described again here. As shown in FIG. 3, this embodiment differs from the first embodiment in that the inner shell 103a is provided with a half-shell shape corresponding to the case of the mobile terminal. The inner shell 103a has a size approximate to half a size of the case of the mobile terminal, and it is slidably coupled to the case of the mobile terminal. Such a slidable connection mode will facilitate the detachment of the mobile terminal. The soft shell 103b, which is arranged in correspondence to the inner shell 103a, is usually made of flexible material, such as leather or fiber material, and so on. The inner shell 103a is mounted on the soft shell 103b by adhering, snap fitting or any other methods.

In order to simplify the connection between the wrist and the wristlet 107, the wristlet 107 is provided at the other end with a connection belt 112 sheathed onto the wrist. The wristlet 107 is spaced from the fingerstall 106 at a distance of about half a length of the palm. As a result, when the mobile terminal is used by the user, it can be held in one hand and leave the palm. In addition, the mobile terminal is secured at a position between the first finger and the third finger, so it is able to move the thumb freely to operate the peripheral controlling member 101 and to carry the mobile terminal by bending the palm and the fingers.

The driving module of the peripheral controlling member 10 may be connected to the mobile terminal by means of, but not limited to, the Bluetooth, i.e., a wireless signal, or the USB data line 111, and any other connection mode by means of a communication signal may also be applied. The connection belt 112 may be connected by a magnetic force or hook and loop fastener or mechanically connected in a plug-in manner, and so on.

The present invention further provides a mobile terminal product including the auxiliary device for the mobile terminal. The peripheral controlling member, which is in wired or wireless communication with the mobile terminal. The peripheral controlling member may adopt a rocker, keyboard or touch panel technique, and so on, and has such functions as stepping, selecting and determining. The peripheral controlling member is operated by the fingers so as to control the mobile terminal. Preferably, the mobile terminal is a press-key mobile phone or a touch-screen mobile phone.

As shown in FIG. 4, the driving mobile is integrated in the peripheral controlling member, and a signal is transmitted via the USB data line or the Bluetooth to the mobile terminal so that it can identify the peripheral controlling member and a setup program for the driving module is loaded, then the peripheral controlling member may be operated by the finger so as to control the mobile terminal. The setup program includes turning the peripheral controlling member on and off, setting priority levels of the input from the peripheral controlling member, the input by pressing keys or touching the screen of the mobile terminal, and adjusting a step size of the peripheral controlling member, and so on. Also, a default setting is provided.

To sum up, the auxiliary device for the mobile terminal of the further embodiment of the present invention includes the fingerstall, the wristlet, the housing and the peripheral controlling member for controlling the mobile terminal. The peripheral controlling member is mounted on the housing, the wristlet is connected to the housing, and the fingerstall is mounted on the back of the housing. The mobile terminal, especially the mobile terminal without any keys, is operated and controlled by the peripheral controlling member in the form of a rocker, keyboard or touch panel, and the mobile terminal, when used, can be held in one hand by means of the auxiliary device. The first finger, the middle finger and/or the third finger are secured in the fingerstalls, and will not occupy the position of the palm. Through the peripheral controlling member in communication with the mobile terminal, it is able to operate and control the mobile terminal by the thumb. As a result, it is able to conveniently hold and carry a large-screen mobile terminal and operate the mobile terminal by one hand, thereby to solve the problem that the large-screen mobile terminal cannot be carried conveniently and must be operated by two hands. In addition, the control of the auxiliary device over the mobile terminal is not limited by its original controlling units, and the carrying and operation of the large-size mobile terminal, such as a mainstream large-screen mobile terminal, will be improved obviously.

The above embodiments are for illustrative purposes only, but shall not be used to limit the present invention. Although the present invention is described with reference to the above embodiments, it should be appreciated that a person skilled in the art may make further modifications or substitutions without departing from the spirit of the present invention, and these modifications or substitutions also fall within the scope of the present invention.

What is claimed is:

1. An auxiliary device for a mobile terminal, comprising a housing for receiving and securing the mobile terminal, and a peripheral controlling member for controlling the mobile terminal, wherein the peripheral controlling member makes identification and exchanges information with the mobile terminal, and the peripheral controlling member is mounted on the housing.

2. The auxiliary device according to claim 1, wherein at least one fingerstall is secured to or detachably mounted on a back of the housing,
a wristlet is secured or detachably connected to the housing , and/or
the peripheral controlling member is secured to, or rotatably mounted on, or detachably mounted on the housing .

3. The auxiliary device according to claim 2, wherein the wristlet is a flexible member with a T-shape, and includes a vertical member and a transverse member arranged at one end of the vertical member, another end of the vertical member is secured or detachably connected to the housing, and the transverse member is configured to be detachably sheathed onto a wrist of a user.

4. The auxiliary device according to claim 3, wherein the transverse member of the wristlet is spaced from the fingerstall at a distance of about half a length of a palm.

5. The auxiliary device according to claim 1, wherein the housing includes an inner shell and a soft shell arranged at a part of, or the whole of, an outer surface of the inner shell, the peripheral controlling member is secured to or rotatably mounted on the inner shell, one end of the wristlet is connected to the soft shell, and the fingerstall is mounted on a back of the soft shell.

6. The auxiliary device according to claim 1, wherein the housing has a shape at its inner side that matches a shape of a case of the mobile terminal, so as to embed or slidably insert the mobile terminal.

7. The auxiliary device according to claim 1, wherein the housing is used as a part of the case of the mobile terminal.

8. The auxiliary device according to claim 2, wherein the transverse member of the wristlet is provided at both ends with a perforated belt and a buckle, or a pair of hook and loop fasteners, or a pair of magnetic buckles, or a pair of snaps, and the transverse member of the wristlet is detachably sheathed onto the wrist.

9. The auxiliary device according to claim 2, wherein there are two or three fingerstalls, and each fingerstall is of a ring shape with an adjustable diameter.

10. The auxiliary device according to claim 1, wherein the peripheral controlling member comprises an input member, a driving module and a signal connection member for making identification and exchanging information with the mobile terminal.

11. The auxiliary device according to claim 10, wherein the input member is a rocker, a keyboard or a touch panel.

12. The auxiliary device according to claim 10, wherein the signal connection member is a wired or wireless signal connection member, and an interface of the driving module is arranged in correspondence to a controlling module of a keyboard or a touch screen of the mobile terminal.

13. The auxiliary device according to claim 2, wherein the peripheral controlling member is arranged at one side of the housing, and the wristlet is also connected to said one side of the housing, and the wristlet is connected at a position where the peripheral controlling member can be operated by a thumb in use.

14. A mobile terminal product, comprising a mobile terminal and an auxiliary device arranged on the mobile terminal, wherein, the auxiliary device comprising a housing for receiving and securing the mobile terminal, and a peripheral controlling member for controlling the mobile terminal, wherein the peripheral controlling member makes identification and exchanges information with the mobile terminal, and the the peripheral controlling member is mounted on the housing.

15. The mobile terminal product according to claim 14, wherein at least one fingerstall is secured to or detachably mounted on a back of the housing,
a wristlet is secured or detachably connected onto the housing, and/or
the peripheral controlling member is secured to, or rotatably mounted on, or detachably mounted on, the housing.

16. The mobile terminal product according to claim 14, wherein the housing has a shape at its inner side that matches a shape of a case of the mobile terminal, so as to embed or slidably insert the mobile terminal, or
the housing is used as a part of the case of the mobile terminal.

17. The mobile terminal product according to claim 14, wherein the peripheral controlling member includes an input member, a driving module and a signal connection member for making identification and exchanging information with the mobile terminal.

18. The mobile terminal product according to claim 17, wherein the input member is a rocker, a keyboard or a touch panel.

19. The mobile terminal product according to claim 17, wherein the signal connection member is a wired or wireless signal connection member, and an interface of the driving module is arranged in correspondence to a controlling module of a keyboard or a touch screen of the mobile terminal.

20. The mobile terminal product according to claim 14, wherein the peripheral controlling member is arranged at one side of the housing, and the wristlet is also connected to said one side of the housing, and the wristlet is connected at a position
where the peripheral controlling member can be operated by a thumb in use.
